(19) United States
(12) Patent Application Publication
(10) Pub. No.: US 2013/0047625 A1
(43) Pub. Date: Feb. 28, 2013

(54) ENHANCED PULSE DETONATION ENGINE SYSTEM

(71) Applicant: William Donald Eatwell, Pearland, TX (US)

(72) Inventor: William Donald Eatwell, Pearland, TX (US)

(73) Assignee: Star Drive Propulsion Systems, LLC, Pearland, TX (US)

(21) Appl. No.: 13/591,393

(22) Filed: Aug. 22, 2012

Related U.S. Application Data
(60) Provisional application No. 61/575,504, filed on Aug. 22, 2011.

(51) Int. Cl. F02C 5/02

(52) U.S. Cl. 60/772; 60/39.38

(57) ABSTRACT

An enhanced pulse detonation engine (PDE) system for application in an aircraft capable of vertical takeoff and vertical landing (VTOVL) is described. The PDE system described herein may be installed onto a round vehicle platform whereby many PDE chamber and ejector tube assemblies are mounted with the ejector tubes facing towards a rotating bladed fan which, in certain embodiments, provides VTOVL flight and gyro stabilization. The angle and design of the fan blades are such that when the fan is rotated by exhaust force, the fan pulls fresh air through the aircraft's interior ducting, cooling the assemblies and adding more air mass for lift. Ignition rotation is adjustable (with or opposite fan rotation) to maximize the fan's thrust output. The design of the fan blade angle is optimized to provide low acoustical detection, low exhaust thrust temperature signature, and maximum air pull-through for lift.

### CROSS-REFERENCE TO RELATED APPLICATIONS

Pursuant to 35 U.S.C. §119(e), this application claims priority from, and hereby incorporates by reference for all purposes, U.S. Provisional Patent Application Ser. No. 61/575,504, entitled “Enhanced Pulse Detonation Engine System,” filed Aug. 22, 2011, and naming William Eatwell as inventor.

### TECHNICAL FIELD

The present disclosure relates generally to pulse detonation engines and, more specifically, to an enhanced pulse detonation engine (PDE) system that incorporates a combustion chamber tube, ejector tube, and fan assembly configuration capable of reducing stresses on components of the PDE system and providing vectored lift.

### BACKGROUND

Current pulse detonation engine technology typically uses a long cylinder or tube design for deflagration to detonation transition (DDT) to achieve high velocity output at an open end of the tube. To achieve maximum thrust output, long cylinder systems require rapid DDT operations of more than 100 times per second. Most of these conventional PDE designs use a two-stage ignition process to achieve detonation, whereby, in the first stage, a fresh air and fuel charge is drawn into the tube and, in the second stage, a smaller amount of volatile fuel (e.g., hydrogen and oxygen) is injected into a trigger chamber and ignited. The ignited charge creates a shockwave that impacts the main air/fuel charge, igniting it into a detonation wave which exhausts out the open end of the tube at supersonic speed and simultaneously draws fresh air into the tube to allow the process to start again.

The detonation wave of conventional PDE systems causes rapid temperature increases, intense noise, and may lead to early failure of the tube. For example, the detonation vibrations occurring during the second stage can be extreme, placing significant stress on the tube materials used in the DDT containment or airframe construction. Moreover, multiple DDT tubes operating out of phase with each other at high frequencies or pulse cycles further adds to high strains from detonation, leading to thermal fatigue and subsequent tube failure. Accordingly, the risk or danger of tube failure is high with conventional PDE systems.

### SUMMARY

Disclosed is one or more embodiments of an enhanced pulse detonation engine (PDE) system that incorporates a combustion chamber and primary nozzle configuration coupled to an ejector tube that, when functioning, produces an accelerated volume of air for system cooling and thrust. In some embodiments, ignition of the chamber is sequential and timed with the fuel/air mix injection mechanism and exhaust process to produce an accelerated air mass. This accelerated air mass impacts a circular rotary bladed fan which, during exhaust thrust powered rotation, simultaneously pulls in fresh air surrounding the PDE chamber(s) and into the ejector tubes thereby increasing the combined air mass output from the fan, which, in some embodiments, can be used for vectored lift and/or flight. In some embodiments, the fuel may be hydrogen gas mixed with oxygen gas or atmospheric air, or a combination of the two. Possible applications of this system may include, for example, terrestrial and space or transatmospheric vehicle propulsion.

The foregoing and other features and advantages of one or more various embodiments of the present disclosure will become further apparent from the following detailed description of the embodiments, read in conjunction with the accompanying drawings. The description and drawings are merely illustrative of one or more various embodiments of the disclosure, rather than limiting the scope of the invention.

### BRIEF DESCRIPTION OF THE DRAWINGS

Embodiments are illustrated by way of example in the accompanying figures (not necessarily shown to scale), in which like reference numbers indicate similar parts, and in which:

FIG. 1A illustrates a profile view of an enclosure housing an embodiment of the disclosed enhanced pulse detonation engine (PDE) system;

FIG. 1B illustrates a side perspective view of the enclosure housing the embodiment of the disclosed PDE system illustrated in FIG. 1A;

FIG. 2A illustrates a top perspective view of the embodiment of the disclosed PDE system in FIG. 1A with the upper chassis and fan assembly removed;

FIG. 2B illustrates a side view of the embodiment of the disclosed PDE system in FIG. 2A;

FIG. 3A illustrates a view of the upper chassis of the PDE system illustrated in FIG. 1A;

FIG. 3B illustrates an underside view of the fan assembly of the PDE system illustrated in FIG. 1A;

FIG. 3C illustrates an underside view of the fan assembly installed on the lower chassis of the PDE system illustrated in FIG. 1A;

FIG. 4A illustrates a close-up perspective view of the embodiment of the disclosed PDE system in FIG. 1A showing an exemplary arrangement of a DDT chamber tube, ejector tube, and the fan assembly;

FIG. 4B illustrates a close-up overhead view of the embodiment of the disclosed PDE system in FIG. 4A;

FIG. 5A illustrates a mechanical feed embodiment of a fuel and ignition system for one or more embodiments of the disclosed PDE system;

FIG. 5B illustrates a valveless embodiment of a fuel and ignition system for one or more embodiments of the disclosed PDE system;

FIG. 6A illustrates an end view of an embodiment of a DDT chamber tube shown from a distal end of the tube;

FIG. 6B illustrates a cross-section view of the DDT chamber tube illustrated in FIG. 6A;

FIGS. 7A and 7B illustrate views of an embodiment of the PDE arrangement including the DDT chamber tube, ejector tube, and rotary bladed fan;

FIGS. 8A, 8B, and 8C illustrate an embodiment of a DDT chamber tube and ejector tube assembly at various stages of the DDT process; and

FIGS. 9A and 9B illustrate an alternate embodiment of the disclosed PDE system, wherein DDT chamber tubes and ejector tubes are arranged in a vertical position over a fan.

### DETAILED DESCRIPTION OF THE DRAWINGS

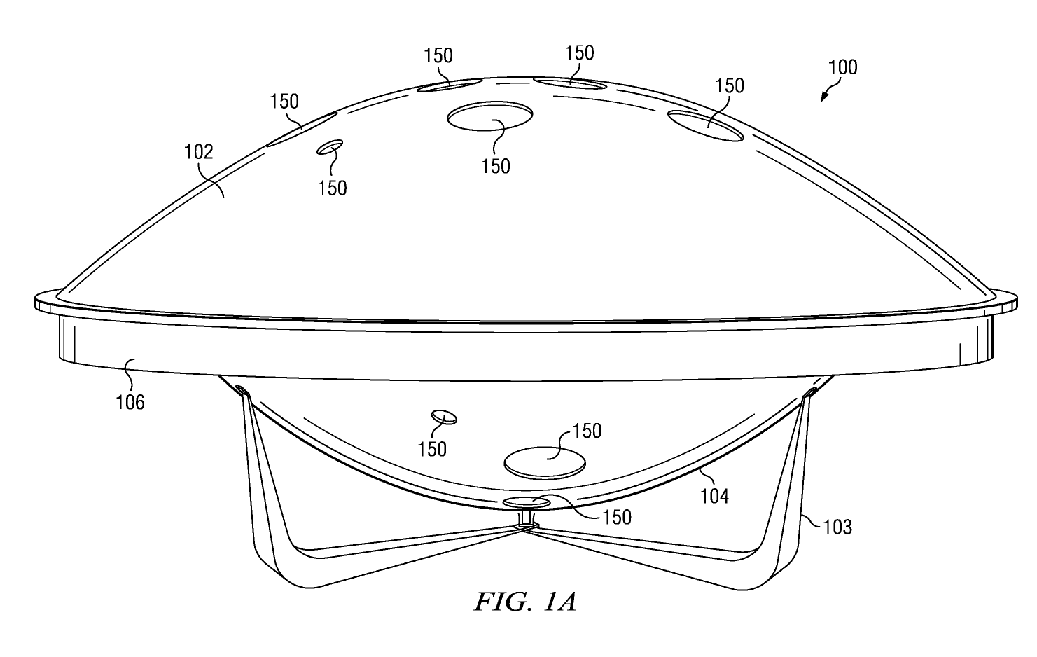

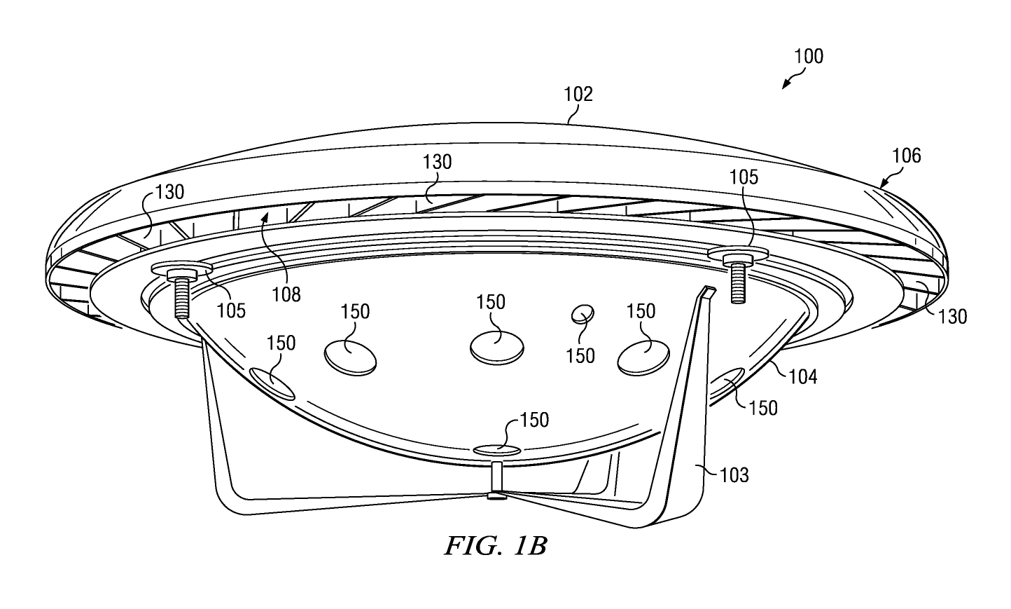

The disclosed enhanced pulse detonation engine (PDE) system is discussed briefly with respect to FIGS. 1-4 (i.e., FIGS. 1A, 1B, 2A, 2B, 3A, 3B, 3C, 4A and 4B), which illustrate various views of an embodiment of the disclosed PDE system. FIGS. 1A and 1B illustrate respective profile and side perspective views of an embodiment of the disclosed (PDE) system 100 housed in an enclosure having an upper chassis 102, a lower chassis 104 and a fan assembly 106 (also referred to herein as a fan). The upper chassis 102 and lower chassis 104 each have openings 150 for providing air ventilation. The lower chassis 104 may, in some embodiments, include one or more support legs 103. The upper chassis 102 may be installed on the lower chassis 104 as shown in FIG. 1A to enclose the PDE system 100. The PDE system 100 further includes roller bearings 105, which allow the fan assembly 106 to rotate freely about the perimeter of the lower chassis 104.

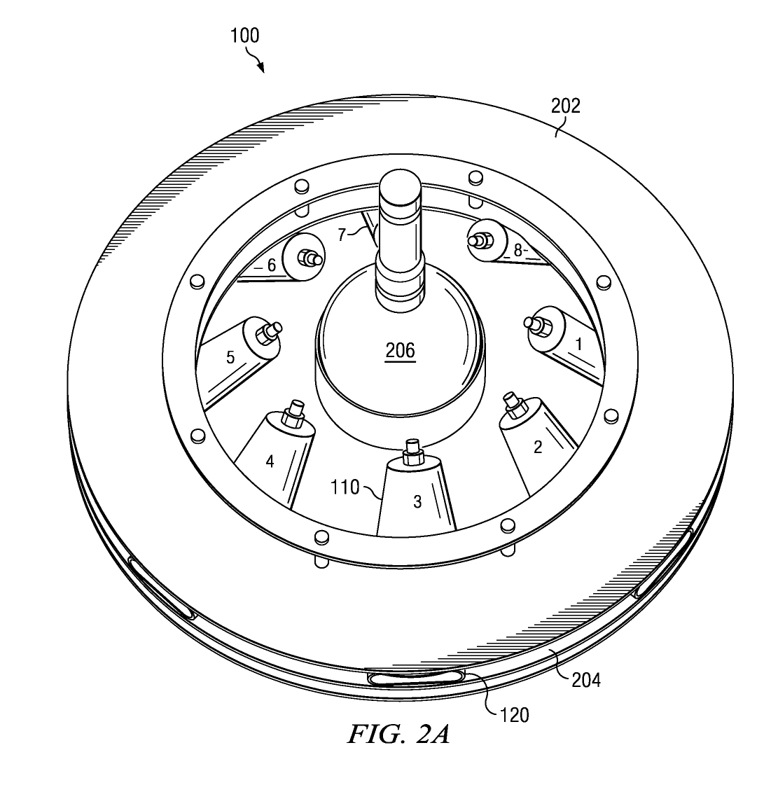

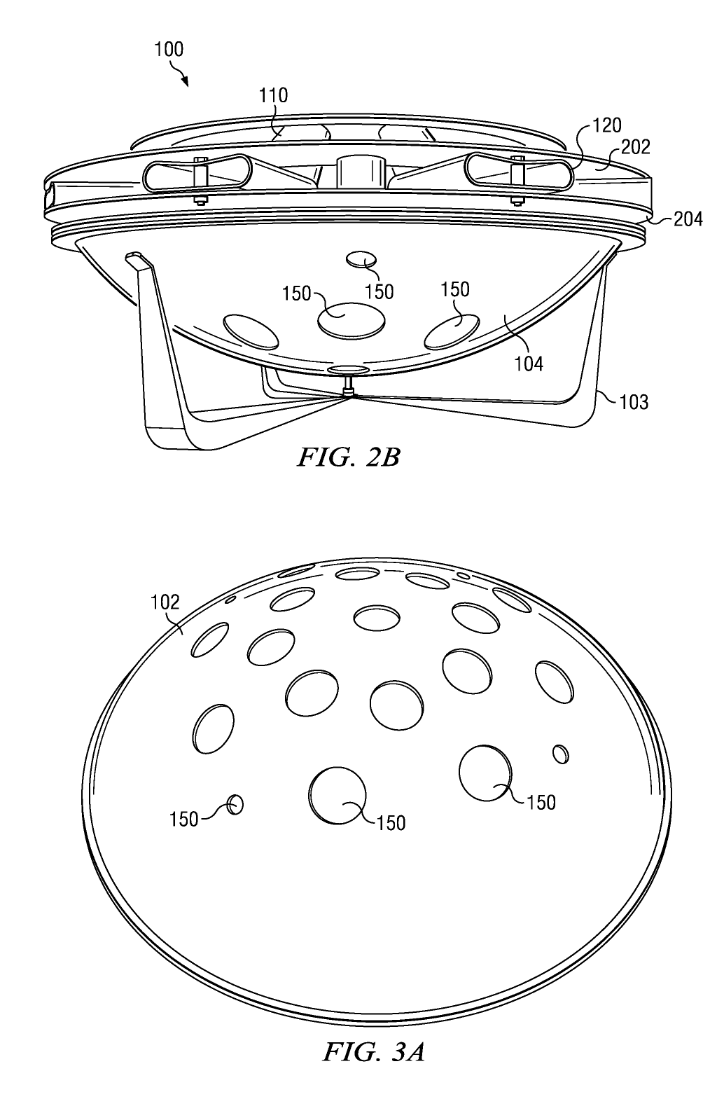

FIGS. 2A and 2B illustrate respective top perspective and side views of the PDE system 100 with the upper chassis 102 and fan assembly 106 removed, and with the fuel and ignition tubes/plumbing omitted from the drawings. As shown in FIG. 2A, one embodiment of the PDE system 100 includes eight DDT chamber tubes 110 (labeled 1-8 in FIG. 2A) and ejector tubes 120 arranged in a radial configuration, wherein the ejector tubes 120 and portions of the DDT chamber tubes 110 may be disposed between an upper plate 202 and a lower plate 204. The configuration of a single DDT chamber tube 110 and a single ejector tube 120 may be referred to herein as a chamber tube and ejector tube assembly, or a DDT assembly. The PDE system 100 illustrated in FIG. 2A further includes a fuel tank 206 disposed in a central cavity of the PDE system 100. Although the fuel tank 206 is illustrated as being located in the central cavity of the PDE system 100, it should be appreciated that, in some embodiments, the tank 206 may be located elsewhere leaving a storage space in place of the tank location shown in FIG. 2A. For example, the fuel tank (or multiple fuel tanks) may be located in the lower chassis 104, and the storage space may be used to house, for example, stability or control equipment, surveillance equipment, tactical weaponry, or any other equipment, circuitry, or items that may be stored in the cavity of the PDE system 100. In some embodiments, the stored equipment or items may be launched or otherwise deployed from the PDE system 100 for example, when in flight, or when grounded.

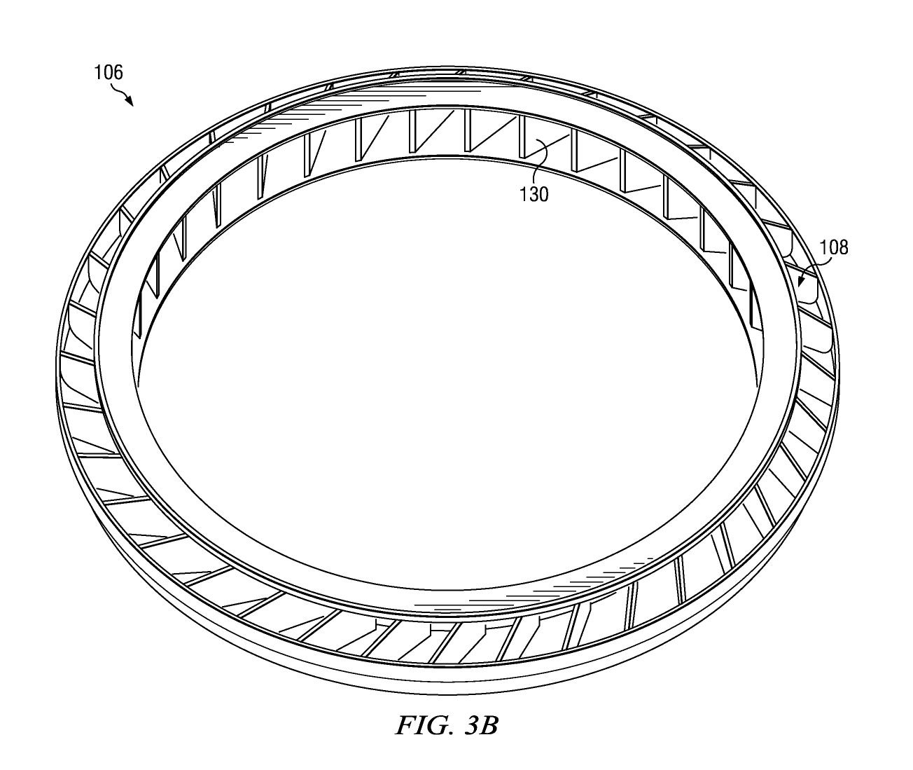

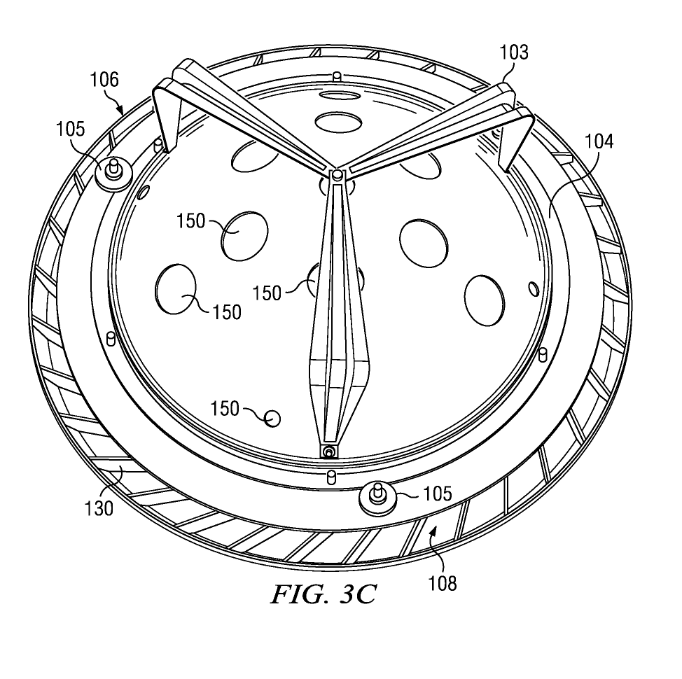

FIGS. 3A, 3B, and 3C illustrate the upper chassis 102, an underside view of the fan assembly 106 in isolation, and the fan assembly 106 installed on the lower chassis 104, respectively. As shown in FIGS. 3B and 3C, the fan assembly 106 includes a plurality of fan blades 130 housed within the fan assembly 106. As explained in greater detail below, the fan assembly 106 is designed to rotate about the lower chassis 104 when powered by an accelerated air mass produced by one or more DDT assemblies. The geometry of the fan blades 130 is such that rotation of the fan 106 causes ambient air to be drawn into the PDE system 100, where it is used to cool the system and to provide thrust as the air is vectored out the bottom opening 108 of the fan assembly 106.

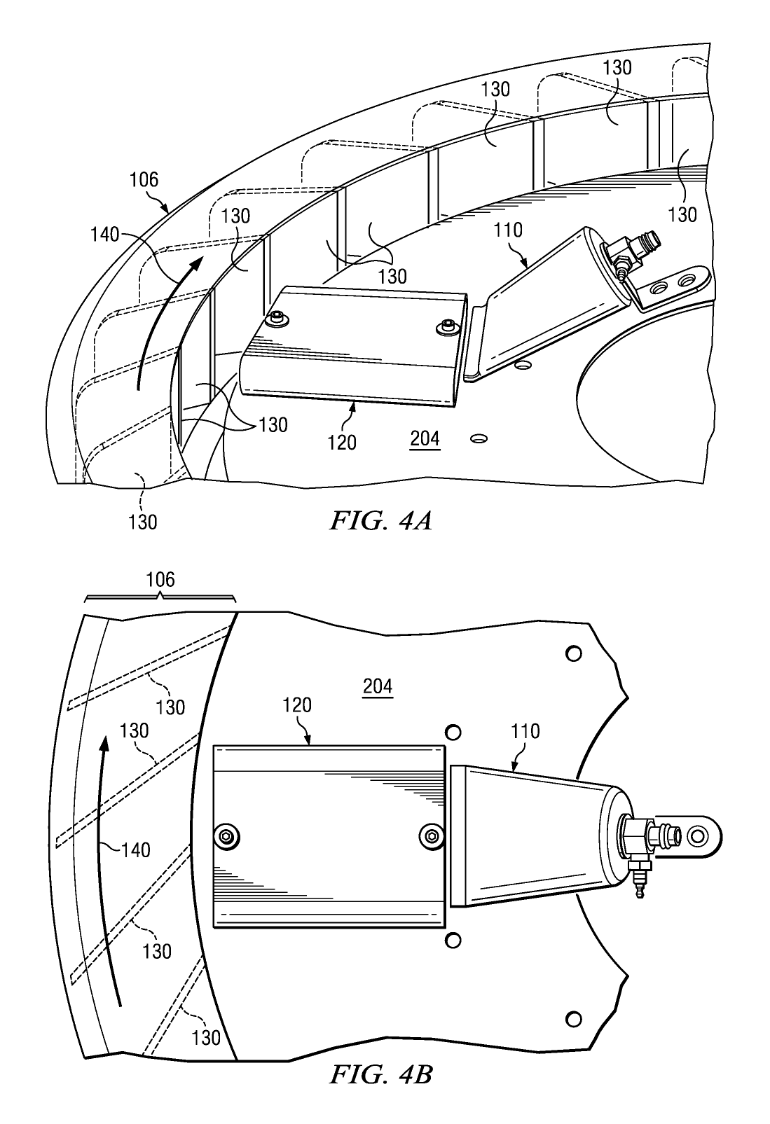

FIGS. 4A and 4B illustrate respective close-up perspective and overhead views of the PDE system 100 showing an exemplary arrangement of a deflagration to detonation transition (DDT) chamber tube 110, ejector tube 120, and fan blades 130 of the fan assembly 106. As shown in FIGS. 2 and 4, the PDE system 100 may incorporate one or more DDT chamber tube 110 and ejector tube 120 assemblies, wherein, in some embodiments, the ejector tubes 120, and a portion of the DDT chamber tubes 110, are generally housed between an upper plate 202 and a lower plate 204. As described in greater detail below, the DDT chamber tubes 110 each receive a mixture of fuel and air and, upon ignition of the fuel/air mixture, provide a deflagration combustion. The deflagration combustion transitions to a detonation combustion producing a detonation wave, which is exhausted from the DDT chamber tube 110, received by the ejector tube 120, and directed towards blades 130 of the fan 106. The exhausted detonation wave provides a rapidly accelerated air mass which impacts the blades 130 of the fan 106, causing the fan 106 to spin. The spinning of the fan 106 (represented by arrow 140) generates a high-velocity, spinning air mass that draws ambient air through openings 150 of the upper chassis 102 and lower chassis 104 to provide thrust and cooling of the PDE system 100. The spinning fan 106 vectors the high-velocity, spinning air mass through the bottom opening 108 of the fan assembly 106, thereby generating thrust that may be used for vectored lift and powered flight of a vehicle incorporating the disclosed PDE system 100.

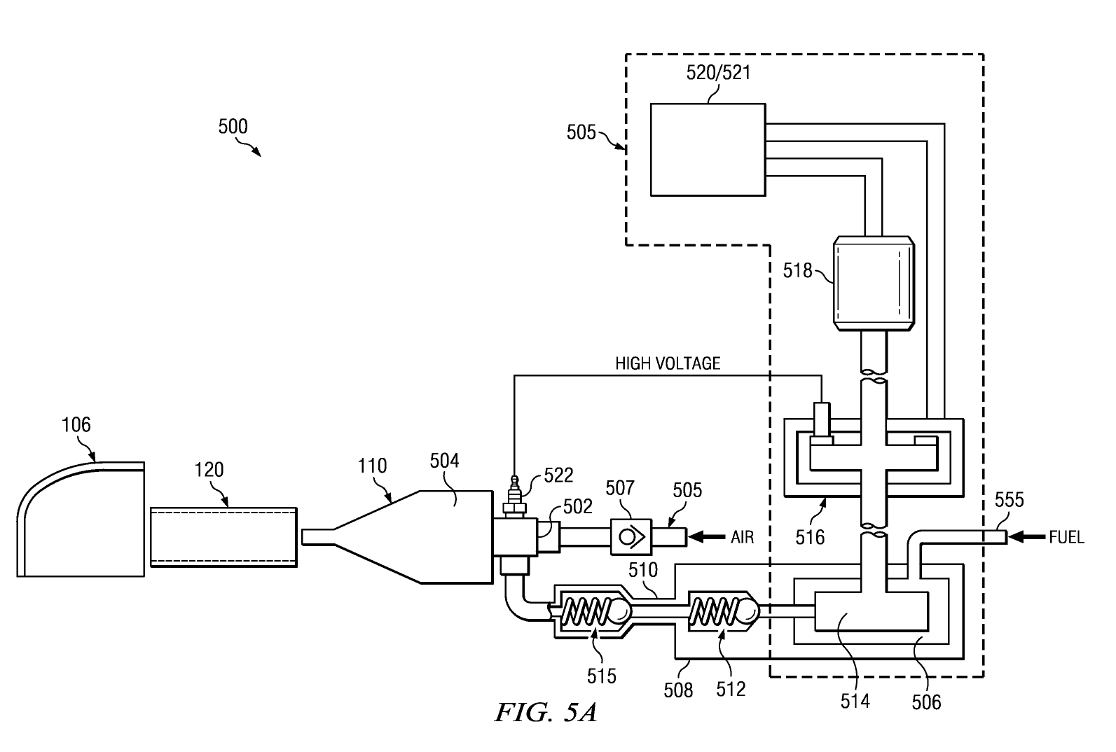

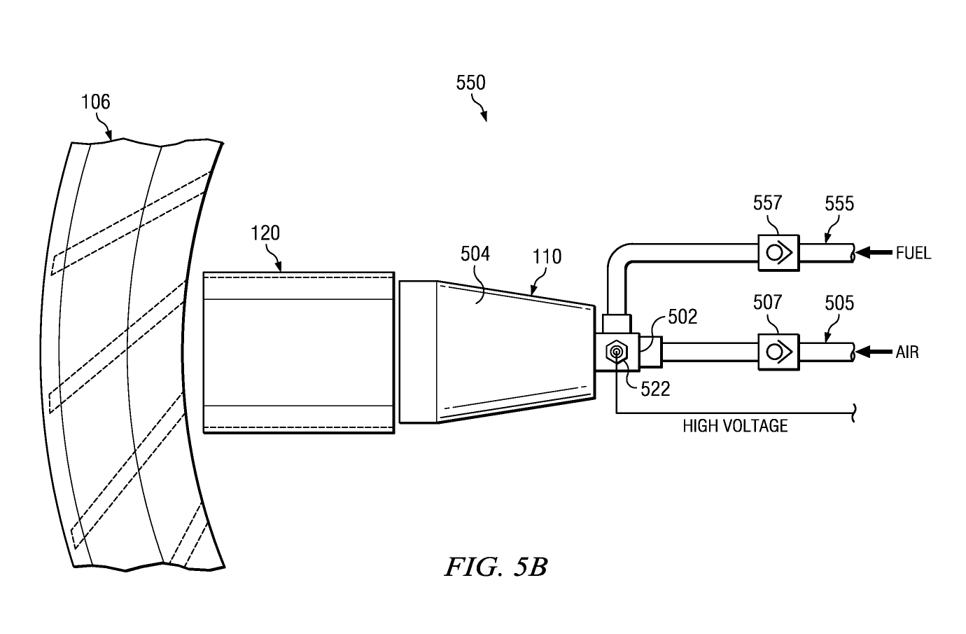

Various embodiments and components of the disclosed PDE system are now discussed in greater detail with respect to FIGS. 5-9.

Reference is now made to FIGS. 5A and 5B, which illustrate example embodiments of fuel and ignition systems for one or more embodiments of the disclosed PDE system. In some embodiments, the central manifold 505 of the PDE system (housed within the upper chassis and lower chassis) contains a rotary seal closed area occupied by a check valve cam 514, and also includes plumbing 505 from pressure regulated hydrogen and oxygen supplies (not shown) and atmospheric air via, in some embodiments, a pump (also not shown). An ignition distributor 516 is mechanically coupled to the manifold cam 514, wherein rotation of both is provided by a variable speed servo motor 518 controlled by control circuitry 520 and a power supply 521.

The fuel and ignition system of FIG. 5A is a mechanical feed embodiment 500, wherein charge or re-charge of a pre-detonator chamber 502 and main, or mixing, chamber 504 of the DDT chamber 110 is provided by a timed, feed-pulsed input of fuel 506 (e.g., hydrogen gas) from a sealed manifold 508 and tubing 510 using a cam-operated check valve 512 enclosed within the sealed manifold 508. In some embodiments, the fuel 506 is supplied to the manifold 508 via a fuel line 555. A secondary check valve 515, designed to block DDT backpressure from traveling back to the cam-operated check valve 512, is located at an entrance of the pre-detonator chamber 502. Air (e.g., oxygen, ambient air, etc.) is fed to the pre-detonator chamber 502 via plumbing 505 and a one-way check valve 507. Once the pre-detonator chamber 502 is charged (or re-charged) with the fuel and air mixture, the cam check valve 512 is closed. Prior to ignition, a timed cycle delay occurs to allow closing of the cam check valve 512 to prevent flashover damage to the manifold system. Once the check valves 512 and 515 are closed, a timed, high voltage ignition spark is delivered from the distributor 516 to a spark plug 522 mounted to the pre-detonation chamber 502, thereby igniting the fuel/air mixture as further described below.

The fuel and ignition system in FIG. 5B is a valveless embodiment 550 which utilizes synchronization of the exhaust and fuel/air feed followed by ignition. In this embodiment, the mechanical feed portion of FIG. 5A (including the cam 514, cam-operated check valve 512, and secondary check valve 515) is removed, and both fuel feed and air feed are provided by regulated and adjustable constant flow sources through tubing 505 and 555 into one-way check valves 507 and 557 located at the entrance of the pre-detonator chamber 502 and spark plug 522. The check valves 507 and 557 prevent the DDT process flame or detonation wave from traveling back to the fuel and air sources, which would otherwise disrupt or stall the fuel and air feed. In some embodiments, the fuel and ignition system may further include servo controlled needle valves for regulating the fuel and/or air sources.

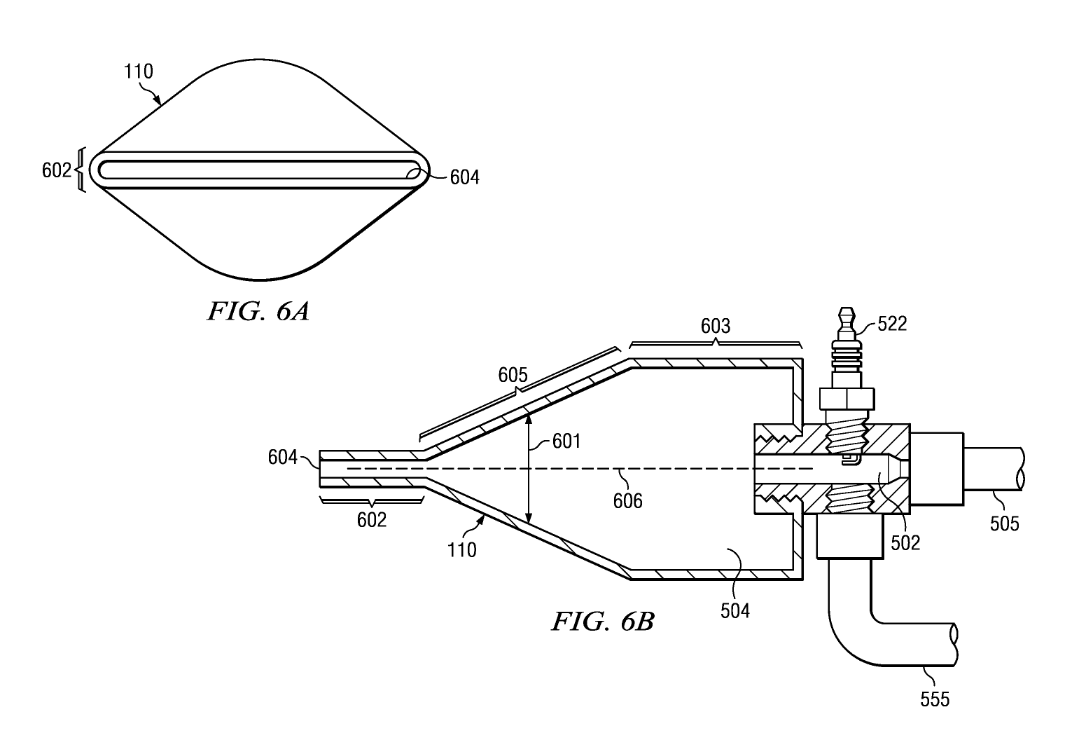

Referring now to FIGS. 6A and 6B, an example embodiment of the DDT chamber tube 110 of FIGS. 2 and 4 is illustrated in greater detail. An end view of the DDT chamber tube 110 is shown in FIG. 6A from a distal end of the tube 110, and a cross-section view of the chamber tube 110 is illustrated in FIG. 6B. In this embodiment, the main chamber 504 of the DDT chamber tube 110 features a generally rounded portion 603 located towards a proximal end of the tube 110 and a wedge-shaped portion 605 having a cross-sectional distance 601 that varies along the length of the respective wedge-shaped portion 605, wherein the wedge-shaped portion 605 tapers from the rounded portion 603 towards the distal end of the tube 110. The distal end of the chamber tube 110 includes an opening 604 defined, in some embodiments, by a flattened portion 602 of the tube 110. The opening 604 of the chamber tube 110 is referred to herein as the ejector gap primary nozzle (or primary nozzle). In some embodiments, the area of the primary nozzle 604 may be substantially equal to the area of a cross-section of the main chamber 504, wherein the cross-section of the main chamber 504 is taken along an axis 606 extending from the proximal end towards the distal end of the tube 110.

The dimensions (e.g., length and diameter) of the DDT chamber tube 110 may affect efficiency of the DDT process. In some embodiments, the DDT chamber tube 110 may have a length approximately twice the diameter of the rounded portion 603 of the chamber tube 110. However, it should be understood that various adaptations of the DDT chamber tube 110 may be made without departing from the scope of the present disclosure as defined in the claims below. For example, in some embodiments, the dimensions (e.g., lengths, widths, angles, etc.) of various portions of the DDT chamber tube may be adjusted for thrust output and to fit the vehicle assembly design. For example, in the embodiment illustrated in FIGS. 6A and 6B, the opening 604 is aligned with the pre-detonator chamber 502, and the shape of the wedge portion 605 is symmetrical about axis 606. However, in some embodiments, the opening 604 may be offset from the pre-detonator chamber 502 such that the wedge-shaped portion 605 is not symmetrical about the axis 606. Additionally, in some embodiments, the generally rounded portion 603 of the DDT chamber tube 110 may be removed such that the wedge-shaped portion 605 begins at the proximal end of the DDT chamber tube 110. In certain embodiments, the DDT chamber tube 110 may not include the flattened portion 602. In such embodiments, the opening 604 may be defined by the tapered end of the wedge-shaped portion 605.

In accordance with the present disclosure, the wedge-type shape of the DDT chamber tube 110 creates a rapid deflagration to detonation transition wave front through wedge ramping and compression of the ignited fuel/air mixture. Accordingly, the disclosed DDT chamber tube 110 causes the deflagration wave front propagation speed to occur quickly, thereby leading to a strong detonation. When compared to conventional PDE systems, the distance traveled by detonation expansion waves is shorter due to the wedge shape of the DDT chamber tube 110, thereby resulting in low expansion loses and a powerful, thin supersonic blast front out the primary nozzle 604.

As shown in FIG. 6B, the DDT chamber tube 110 further includes, at its proximal end, the aforementioned pre-detonator or “trigger” chamber 502, spark plug 522, and air and fuel lines 505 and 555. It should be appreciated that the embodiment illustrated in FIG. 6B may use the valveless fuel system shown in FIG. 5B; however, in alternate embodiments, the mechanical feed system shown in FIG. 5A could be used.

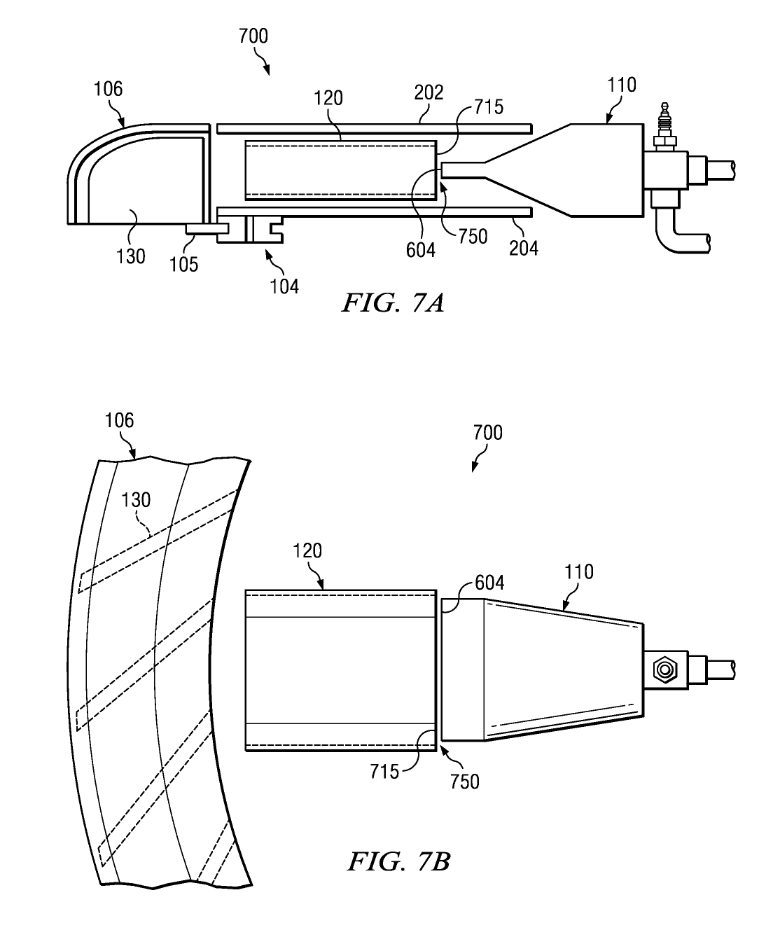

Reference is now made to FIGS. 7A and 7B, each illustrating an embodiment of a DDT chamber tube and ejector tube assembly 700. FIG. 7A illustrates a profile view of a portion of the lower chassis 104 (including upper and lower plates 202 and 204) housing a DDT chamber tube 110, ejector tube 120, and fan assembly 106. FIG. 7B illustrates an overhead view of the assembly 700 with the upper and lower plates 202 and 204 removed. Adjacent the primary nozzle 604 of the DDT chamber tube 110 is an ejector tube 120. The ejector tube 120 has a nozzle opening 715 (referred to herein as a secondary nozzle), in some embodiments, having an opening 2-3 times the size of the opening of the primary nozzle 604, and having a shape substantially identical to the shape of the primary nozzle 604. The secondary nozzle 715 of the ejector tube 120 is positioned at a defined distance from the primary nozzle 604 to provide a gap 750 between the ejector tube 120 and the DDT chamber tube 110. Although it is not shown in FIGS. 7A and 7B, in some embodiments, the gap 750 may be maintained by a physical barrier such as, for example, a bracket mounted to the DDT chamber tube 110 and the ejector tube 120.

The distance of the gap 750 between the primary nozzle 604 and the secondary nozzle 715 of the ejector tube 120 is set in accordance with prototype testing. A gap distance ranging from ⅛ inch to 3/16 inch between the primary nozzle 604 and the secondary nozzle 715 creates a preferred distance to produce a desired primary nozzle 604 output blast on the entrained and moving air mass within the ejector tube 120. This fixed distance improves air mass attenuation, which allows fresh air to flow unimpeded into the ejector tube 120. The mixing of hot supersonic blast from the primary nozzle 604 into the cooler air of the ejector tube 120 delivers a large mass of air at lower temperatures that enhances the life of the lift fan 106 and other components in the PDE system.

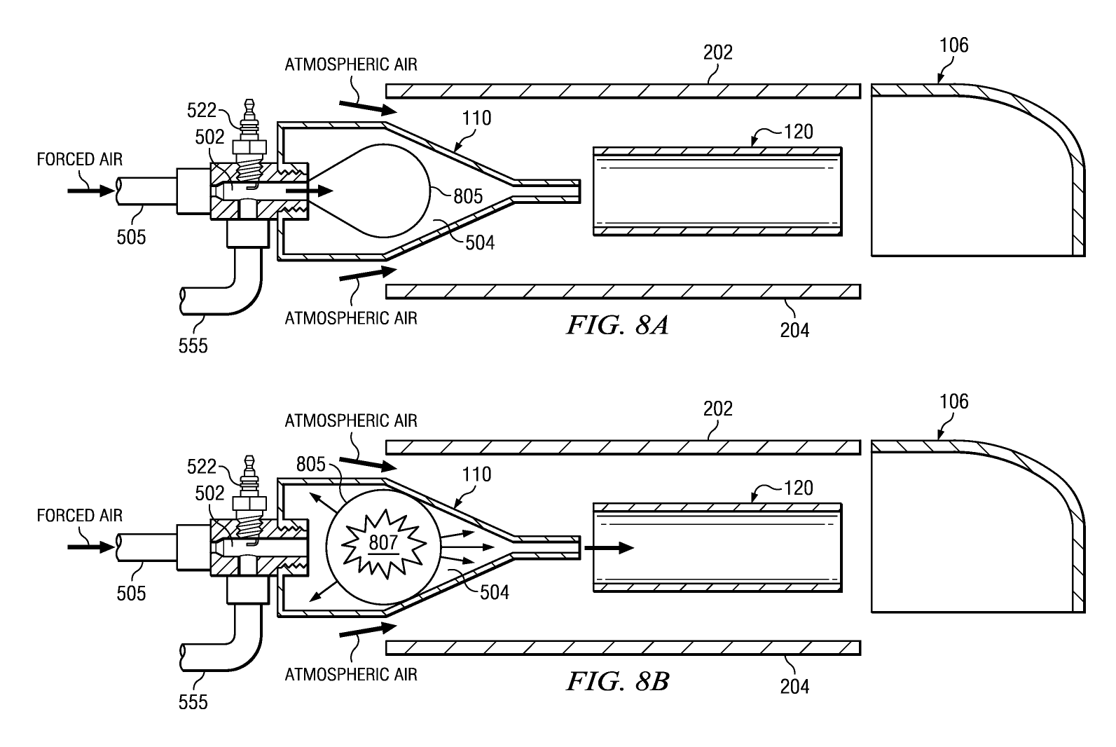

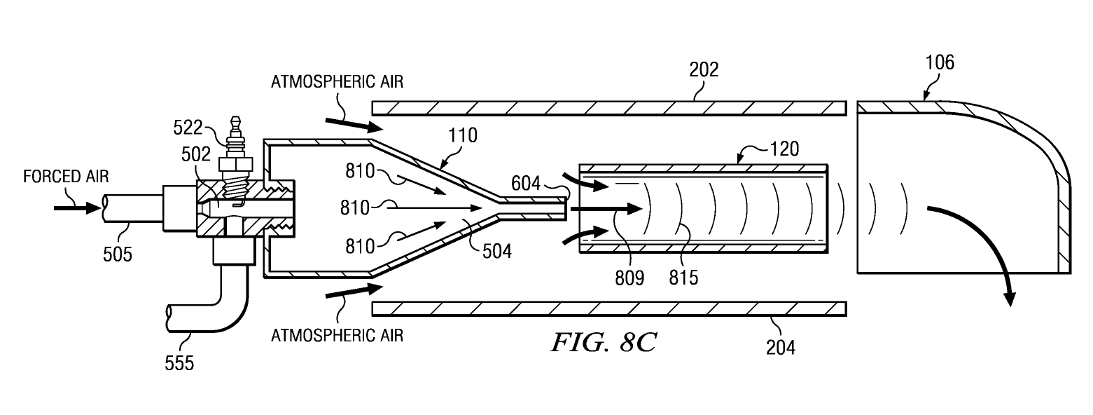

The DDT process is further described herein with respect to FIGS. 8A-8C, which illustrate an embodiment of a DDT chamber tube 110 and ejector tube 120 assembly disposed between an upper plate 202 and lower plate 204. In the embodiment illustrated in FIGS. 8A-8C, the DDT chamber tube 110 includes a pre-detonator chamber 502, spark plug 522, and air and fuel lines 505 and 555. In the interest of simplicity, the fan blades 130 are not shown attached to the fan assembly 106 illustrated in FIGS. 8A-8C.

As shown in FIG. 8A, each chamber tube 110 is simultaneously force-fed fresh fuel and air into the pre-detonator chamber 502 and into the main chamber 504, where they form a pressure-pulsed charge of a fuel/air mixture 805.

Referring now to FIG. 8B, the charge of fuel and air 805 is timed to ignite in a defined timing sequence. In some embodiments, this sequence may be defined relative to the timing of the immediate chamber tube 110, other chamber tubes in the PDE system, or both. The ignition is provided by a timed high voltage spark generated by the spark plug 522, thereby igniting the fuel/air mixture 805 and initiating the DDT process. The short DDT chamber tube 110 creates a quick and strong deflagration, leading to a strong detonation 807. In some tested embodiments, the short DDT chamber tube 110 produces a detonation 807 having an acoustical output of approximately 160 dB.

Referring now to FIG. 8C, the wedge shape of the DDT chamber tube 110, which ends at the ejector gap primary nozzle 604, creates a supersonic, thin detonation blast wave 809, which is exhausted out the primary nozzle 604 before the next timed re-charge begins. This timing action allows for backpressure 810, generated by the current detonation, to dissipate so that the incoming re-charge feed (i.e., the fresh air and fuel for the next detonation) is not stalled or disrupted. In some embodiments, fresh atmospheric air, oxygen, or both, is pumped continuously through the tubing and one-way valves (see FIGS. 5A and 5B) connected to each pre-detonator chamber 502. In some embodiments, this fresh atmospheric air and/or oxygen may be drawn into the enclosure by the fan 106. This fresh air feed helps clear burned products out of the DDT chamber tube 110, and assists in cooling the chamber tube 110, ejector tube 120, fan 106, and other components, which may promote long-term operation of the PDE system.

The supersonic thin detonation blast wave 809 exhausts from the primary nozzle 604 and impacts static or moving air 815 in the adjacent ejector tube 120 causing a “billiard ball effect” which rapidly accelerates the air mass within the ejector tube 120. This accelerated mass of air inside the ejector tube 120, a mix of both supersonic and subsonic flow from the primary nozzle 604, is routed directly into the fan assembly 106. As the ejector air mass impacts the angled fan blades (not shown), high velocity flow across the blades causes the fan 106 to rotate, and accelerate with force, which then pulls more air mass through the ejector tube 120 (and other ejector tubes in the PDE system) and around each DDT chamber tube 110 to assist in chamber cooling and generating a thrust for vectored lift and powered flight. As previously mentioned, the resultant acoustical output from each chamber tube 110 may be approximately 160 dB, and typical of an efficient DDT action. However, in some embodiments, the spinning fan 106 may reduce this acoustic output. After the DDT process, and detonation/ejection is complete, the re-charge process begins again and may continue until fuel is shut off.

Referring briefly to FIG. 2A, the PDE system 100 includes eight DDT chambers 110 arranged in a radial, circular arrangement with ejector tube outlets facing the inner ring of the mounted fan blades 130, and a fuel tank 206 located in the center cavity of the PDE system 100. The chambers are identified in FIG. 2A as respective chambers 1-8. As mentioned above, the disclosed PDE system implements sequential spark ignition timing of each chamber 110 in the PDE system 100 (e.g., chambers 1-8 of the PDE system shown in FIG. 2A), wherein, in some embodiments, the frequency of each chamber firing is approximately one firing per second. In some embodiments, this timing speed may be determined in accordance with the ignition distributor RPM, and may be chosen to allow for optimum recharge time of the fired chambers 110.

In another embodiment, the ignition firing may be timed such that two opposing DDT chambers 110 in the PDE system 100 are fired simultaneously. For example, in the eight-chambered assembly illustrated in FIG. 2A, chamber firing may occur in the following sequence: chambers 1 and 5, chambers 2 and 6, chambers 3 and 7, and then chambers 4 and 8. The timing speed may also be determined in accordance with the ignition distributor RPM and may be chosen to allow for optimum recharge time of each fired chamber 110.

In yet another embodiment, all DDT chambers may be fired simultaneously and timed to allow for a complete fuel and air recharge of all chambers 110 before repeating the firing sequence.

It should be appreciated that, in the disclosed embodiments, the order of the firing sequence may be either clockwise or counterclockwise. Additionally, in accordance with the foregoing timing sequences, the downstream detonation shock interaction between spaced out DDT chambers 110 in the PDE system 100 is significantly reduced as the rotating fan blades 130 absorb and react with the individual ejector thrust forces thereby reducing flow losses.

In some embodiments, it may be beneficial to initialize fan rotation prior to PDE ignition sequence start. One such method for initializing fan rotation is through the use of an air start blower similar in design to those used in jet engine starting. High air flow from a small blower is piped next to the PDE DDT chambers 110 and aimed toward the fan blades 130 at a fixed angle, thereby causing the fan 106 to begin rotating prior to ignition and DDT thrust output. This fan start method assists the DDT thrust process as the sequentially ignited ejector output thrust impacts the moving fan blades 130, causing increased acceleration of the fan 106 to a rotational speed for lift and flight vectoring. In some embodiments a bleed-off can be used as the fresh air source.

In some embodiments, the materials comprising the DDT chamber tubes 110 may include, for example, aluminum, brass, or steel. In some embodiments, the ejector tube 120 and lift fan 106 may be formed, for example, from aluminum or a composite material. In some embodiments, the PDE chassis may be formed of high temperature materials designed to withstand high temperatures associated with long-term operation of the DDT chamber tubes 110, ejector tubes 120, and the rotating lift fan 106. These materials may include alloys typically used for jet engines and aircraft such as, for example, nickel alloy metals, ceramic matrix composites, titanium, and magnesium.

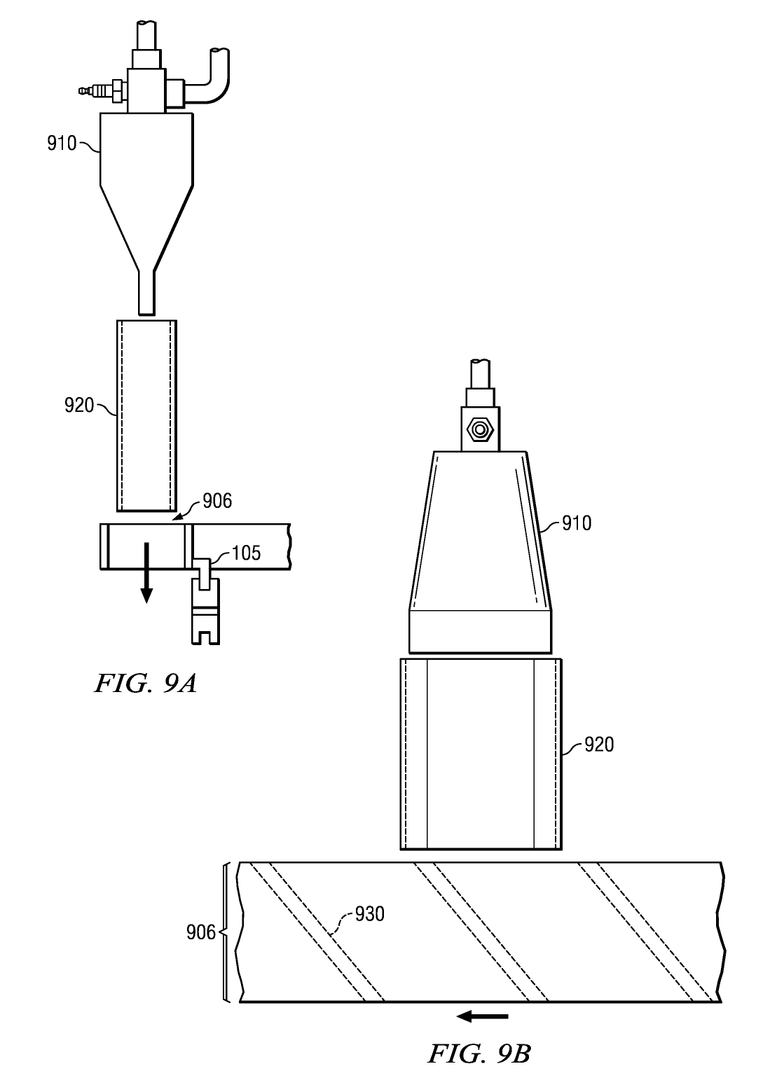

Although the DDT chambers as shown in FIGS. 2A and 2B are arranged in a flat or radial circular arrangement with ejector tube outlets facing the inner ring of the mounted fan blades, it should be appreciated that the disclosed PDE system may include embodiments wherein the DDT chambers and ejector tubes are positioned in a vertical arrangement over a straight lift fan. Such an example embodiment is illustrated in FIGS. 9A and 9B, wherein one or more DDT chamber tubes 910 and ejector tubes 920 are arranged in a vertical position over a fan 906 such that output thrust from the chamber and ejector tube assembly impacts the fan blades 930 from an overhead direction.

It should be appreciated that the foregoing PDE system may be used in a vehicle for air travel wherein, in some embodiments, flight control and stability during vertical and horizontal travel, as well as to counterbalance the craft during and/or after launching of any stored or attached equipment, may be provided through control motion gyros, or similar technology. In some embodiments, flight control may be provided by some type of control vane acting on the downward air mass flowing off the spinning fan.

The description of the invention as set forth in the present disclosure is not intended to be exhaustive or to limit the invention to the precise form or embodiments disclosed. Other features and advantages of the present invention may be apparent to those of ordinary skill in the art upon reference to the accompanying drawings and the foregoing description of the drawings. Many modifications and variations are possible in view of the foregoing disclosure without departing from the spirit and scope of the following claims.

What is claimed is:

1. A pulse detonation engine system, comprising:
one or more deflagration-to-detonation transition (DDT) assemblies, each DDT assembly comprising:
an ignition source operable to ignite a fuel and air mixture to initiate a deflagration combustion,
a DDT chamber tube having a chamber for receiving the fuel and air mixture and an opening for exhausting a detonation wave generated when the deflagration combustion transitions within the chamber to a detonation combustion producing the detonation wave, and
an ejector tube having a first opening for receiving the detonation wave exhausted from the DDT chamber tube opening, the exhausted detonation wave accelerating an air mass within the ejector tube, wherein the ejector tube is operable to direct the accelerated air mass towards a second opening of the ejector tube; and
a fan operable to receive the accelerated air mass from the second opening of the ejector tube, the accelerated air mass exerting a force on blades of the fan causing the fan to rotate.

2. The pulse detonation engine system of claim 1, wherein the ejector tube is disposed at a fixed distance from the opening of the DDT chamber tube such that rotation of the fan draws ambient air through the first opening of the ejector tube to provide at least one of an increase in the accelerated air mass and cooling of one or more components of the pulse detonation engine system.

3. The pulse detonation engine system of claim 1, wherein the chamber has a cross-sectional distance that varies along a length of the chamber.

4. The pulse detonation engine system of claim 1, further comprising an upper chassis member and a lower chassis member for housing the one or more DDT assemblies.

5. The pulse detonation engine system of claim 4, wherein at least one of the upper chassis member and the lower chassis member includes one or more openings for receiving ambient air.

6. The pulse detonation engine system of claim 4, wherein the ignition source comprises a spark plug.

7. The pulse detonation engine system of claim 6, wherein the ignition source further comprises an ignition distributor operable to provide a timed high voltage ignition spark to the spark plug.

8. The pulse detonation engine system of claim 1, further comprising a central manifold housing at least one of a fuel source and an air source.

9. The pulse detonation engine system of claim 1, wherein the DDT chamber tube has a length approximately twice a diameter of the DDT chamber tube.

10. The pulse detonation engine system of claim 1, further comprising a fuel system, the fuel system comprising:
a cam operable to be controlled by a motor;
a primary check valve operated by the cam to supply fuel to the DDT chamber tube; and
a secondary check valve operable to block backpressure from the DDT chamber tube.

11. The pulse detonation engine system of claim 1, further comprising a fuel system, the fuel system comprising:
a servo controlled needle valve operable to regulate a pressured fuel source with constant fuel flow to the DDT chamber tube;
a first one-way check valve operable to prevent backflow to the fuel source; and
a second one-way check valve operable to prevent backflow to an air source.

12. The pulse detonation engine system of claim 1, wherein a plurality of DDT assemblies are arranged in a radial configuration such that the second openings of the ejector tubes each provide an accelerated air mass received by the fan.

13. The pulse detonation engine system of claim 1, wherein ignition of the fuel and air mixture is timed to allow dissipation of backpressure in the chamber after each detonation combustion.

14. The pulse detonation engine system of claim 1, wherein the pulse detonation engine system is operable to be installed in a vehicle to provide at least one of gyroscopic stability, vectored lift, and flight of the vehicle.

15. A method for providing thrust in a pulse detonation engine system, the method comprising:
mixing fuel and air in one or more deflagration-to-detonation transition (DDT) chambers;
igniting the mixture of fuel and air in the one or more DDT chambers to initiate a deflagration combustion, wherein the deflagration combustion transitions within the respective DDT chamber to a detonation combustion;
outputting a detonation wave produced by the detonation combustion to an ejector tube, the detonation wave accelerating an air mass within the ejector tube; and
directing the accelerated air mass to a fan, the accelerated air mass exerting a force on blades of the fan causing the fan to rotate and generate thrust;
wherein the one or more DDT chambers have a cross-sectional distance that varies along a length of the respective chamber to provide compression of the deflagration combustion and the detonation combustion.

16. The method of claim 15, wherein the ignition of the fuel and air mixture is timed to allow dissipation of backpressure in the chamber after each detonation combustion.

17. The method of claim 15, wherein the ejector tube is disposed at a fixed distance from an opening of the DDT chamber such that rotation of the fan draws ambient air through an opening of the ejector tube to provide at least one of an increase in the accelerated air mass and cooling of one or more components of the pulse detonation system.

18. The method of claim 15, wherein the fuel is provided by a fuel system, the fuel system comprising:
a cam operable to be controlled by a motor;
a primary check valve operated by the cam to supply fuel to the DDT chamber; and
a secondary check valve operable to block backpressure from the DDT chamber.

19. The method of claim 15, wherein the fuel is provided by a fuel system, the fuel system comprising:
a servo controlled needle valve operable to regulate a pressured fuel source with constant fuel flow to the DDT chamber;
a first one-way check valve operable to prevent backflow to the fuel source; and
a second one-way check valve operable to prevent backflow to an air source.

20. The method of claim 15, wherein the one or more DDT chambers and ejector tubes are arranged in a radial configuration such that each ejector tube directs an accelerated air mass to the fan.

21. The method of claim 15, further comprising igniting the mixture of fuel and air in the one or more DDT chambers in a sequential order.
